(19) United States
(12) Patent Application Publication
(10) Pub. No.: US 2026/0340247 A1
(43) Pub. Date: Oct. 29, 2026

(54) METHOD AND APPARATUS FOR REDUCING TURNAROUND TIME IN STATIC TIMING CONSTRAINTS DEBUGGING AND ETM GENERATION

(71) Applicant: Samsung Electronics Co., Ltd, Gyeonggi-do (KR)

(72) Inventors: Hongda LU, Austin, TX (US); Mayur AGARWAL, Austin, TX (US)

(21) Appl. No.: 19/287,297

(22) Filed: Jul. 31, 2025

Related U.S. Application Data
(60) Provisional application No. 63/793,359, filed on Apr. 23, 2025.

(51) Int. Cl. G06F 30/3315; G06F 30/3323

(52) U.S. Cl. CPC G06F 30/3315; G06F 30/3323

(57) ABSTRACT

A system and a method are disclosed for reducing static timing analysis (STA) runtime in a hierarchical circuit design. The method includes receiving a register-transfer level (RTL) description of a plurality of design blocks; selecting one or more blocks from the plurality of design blocks for logic trimming; identifying, within the one or more selected blocks, a logic element; removing the identified logic element from the RTL description prior to synthesis; and generating a trimmed RTL representation for the one or more selected blocks.

### CROSS-REFERENCE TO RELATED APPLICATION

This application claims the priority benefit under 35 U.S.C. § 119(e) of U.S. Provisional Application No. 63/793,359, filed on Apr. 23, 2025, the disclosure of which is incorporated by reference in its entirety as if fully set forth herein.

### TECHNICAL FIELD

The disclosure generally relates to electronic design automation (EDA). More particularly, the subject matter disclosed herein relates to improvements to reducing turnaround time for static timing analysis (STA) and extracted timing model (ETM) generation.

### SUMMARY

As integrated circuit (IC) designs continue to grow in size and complexity, the time required to perform STA at the top level of a hierarchical design has become a significant challenge. Because top-level STA often depends on the completion of lower-level blocks, delays in sub-block implementation can stall the entire design flow. In particular, the development and verification of timing constraints, as well as the generation of ETMs, are often gated by the availability of fully synthesized and routed block-level designs.

To address this problem, some existing methodologies rely on abstract representations of blocks to reduce the computational burden of full-chip STA. These techniques typically involve generating timing models from completed physical implementations of sub-blocks, allowing those blocks to be reused more efficiently in the top-level context.

However, such approaches still require a complete implementation of each block before abstraction is possible. As a result, these flows do not reduce the overall turnaround time at the block level and may even introduce additional delay at the top level due to the time spent generating abstraction models.

To overcome these limitations, systems and methods are described herein for simplifying sub-blocks before they are fully implemented. According to various embodiments, unnecessary logic is removed from a register-transfer level (RTL) description of a design based on its relevance to top-level timing. This trimming can be applied selectively across blocks, enabling significantly faster processing in downstream stages. The approach may be particularly well suited to designs where timing-critical logic is concentrated at the interface level, such as abutted designs.

The above approaches improve on previous methods by simplifying blocks at the RTL level, which allows top-level timing analysis and ETM generation to begin earlier and be completed more quickly. This in turn improves the efficiency of timing constraint development and helps accelerate the rate of overall chip design.

According to an embodiment, a method for reducing STA runtime in a hierarchical circuit design. The method includes receiving an RTL description of a plurality of design blocks; selecting one or more blocks from the plurality of design blocks for logic trimming; identifying, within the one or more selected blocks, a logic element; removing the identified logic element from the RTL description prior to synthesis; and generating a trimmed RTL representation for the one or more selected blocks.

According to another embodiment, an apparatus includes a processor, and a non-transitory computer-readable storage medium storing instructions that, when executed by the processor. The instructions, when executed by the processor, cause the apparatus to receive an RTL description of a plurality of design blocks, select one or more blocks from the plurality of design blocks for logic trimming, identify, within the one or more selected blocks, a logic element, remove the identified logic element from the RTL description prior to synthesis, and generate a trimmed RTL representation for the one or more selected blocks.

### BRIEF DESCRIPTION OF THE DRAWING

In the following section, the aspects of the subject matter disclosed herein will be described with reference to exemplary embodiments illustrated in the figures, in which:

FIG. 1 is an example system configured to perform RTL trimming for accelerating STA and/or ETM generation, according to an embodiment;

FIG. 2 is a flowchart illustrating a method for trimming design logic to accelerate STA and/or ETM generation in hierarchical designs, according to an embodiment;

FIG. 3 is a flowchart illustrating a design trimming method for reducing unnecessary RTL logic within one or more blocks prior to synthesis and STA, according to an embodiment;

FIG. 4 is a flowchart illustrating a method for reducing STA runtime in a hierarchical circuit design, according to an embodiment; and

FIG. 5 is a block diagram of an electronic device in a network environment, according to an embodiment

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures(including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an IC, system on-a-chip (SoC), an assembly, and so forth.

“ETM” as used herein refers to an extracted timing model, which is a compact representation of a design block’s timing behavior used for hierarchical STA. Some examples of “ETM” are block-level timing abstraction models generated after synthesis or place-and-route that preserve interface timing characteristics while omitting internal logic details.

“STA” as used herein refers to static timing analysis, a method for verifying the timing performance of a digital circuit without requiring simulation. Some examples of “STA” are full-chip timing closure, constraint debugging, and timing validation using top-level or hierarchical models.

“RTL” as used herein refers to register-transfer level, a high-level hardware design abstraction that describes the data flow and control logic of a digital circuit in terms of registers and the operations performed on data between clock edges. Some examples of “RTL” are Verilog or very high speed IC (VHSIC) hardware description language (VHDL) modules that describe combinational and sequential logic structures prior to synthesis.

“Trimmed RTL representation” as used herein refers to a reduced version of a register-transfer level netlist in which logic elements determined as non-essential to top-level STA are removed. This reduction may be based on design knowledge and STA objectives, such as timing constraint debugging or ETM generation. An example of “trimmed RTL representation” is an RTL netlist in which logic elements that do not contribute to timing paths relevant to top-level STA have been removed, while cells or modules marked as “dont_touch” are preserved.

“Block,” “partition,” or “tile” as used herein refer to a logical subdivision of a circuit design, typically representing a modular portion of a larger hierarchical system. These terms may be used interchangeably. Some examples of a “block,” “partition,” or “tile” are distinct functional modules within a systems-on-chip (SoC), such as a memory controller, interface engine, or arithmetic unit, each implemented and verified separately during design.

“Dont_touch labels” as used herein refer to annotations or directives applied to RTL modules or instances to prevent their removal or modification during trimming or optimization. Some examples of “dont_touch labels” are tool-specific attributes in Verilog, which instruct the logic trimming process to preserve the marked elements for purposes such as timing relevance.

“Logic element” as used herein refers to a functional unit within a hardware design that implements digital logic behavior. Logic elements may include combinational logic (such as AND, OR, and XOR gates), sequential elements (such as flip-flops or latches), or higher-level constructs like multiplexers and arithmetic units. Some examples of “logic element” are RTL-defined instances such as a multiplexer controlling data flow, a register storing state information, or a gate-level netlist element contributing to a timing path.

This disclosure relates to improving the design process for ICs, particularly at advanced scales where chips contain many hierarchical sub-blocks. In semiconductor design, STA may be used to verify that signals meet timing requirements across the chip. STA is a step in ensuring that chips function correctly at their intended speeds.

However, as chip designs grow in complexity, especially in SoCs and graphics processor units (GPUs), top-level STA becomes increasingly time-consuming. This is due to the dependency on every sub-block being fully implemented (e.g., synthesized, placed, and routed) before top-level timing analysis can begin. In large designs, such as those with 20 or more blocks, the overall schedule is often gated by the slowest block, delaying the entire project. Similarly, ETM generation used for block abstraction also suffers from the same delay, since it typically requires completed physical layouts of sub-blocks.

To accelerate the design process, the technology described in this disclosure generates a trimmed RTL representation of a selected block by applying a lightweight trimming step at the RTL to remove logic from the block that is not relevant to top-level STA or ETM generation before synthesis and physical implementation, thereby reducing block size and processing time. This allows blocks to be processed more quickly and enables earlier top-level integration, effectively bypassing the bottleneck caused by waiting for full implementation of every block.

Accordingly, implementation of one or more of the embodiments disclosed herein may reduce the chip design and verification turnaround time. This contributes to faster project schedules and improved responsiveness in fast-paced product cycles, such as mobile, GPU, or SoCs.

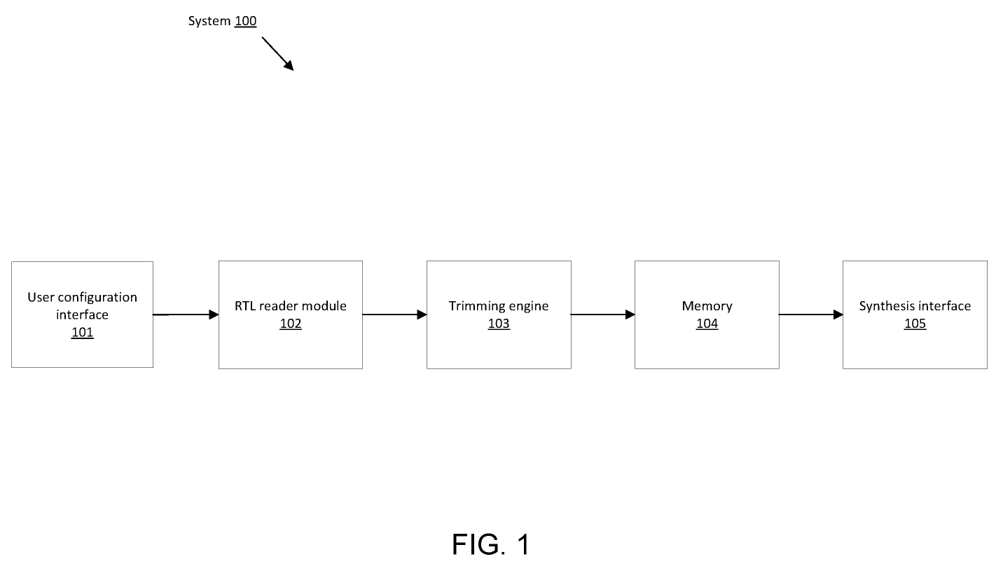

FIG. 1 is an example system configured to perform RTL trimming for accelerating STA and/or ETM generation, according to an embodiment.

Referring to FIG. 1, the system 100 may include a user configuration interface 102 that allows a user to specify logic blocks or modules to preserve for top-level timing analysis. The user configuration interface 101 is coupled to an RTL reader module 102 that is configured to sequentially receive RTL files corresponding to individual sub-blocks.

The RTL data is provided to a trimming engine 103, which is configured to identify logic marked for preservation (e.g., via “dont_touch” labels) and remove other RTL elements that are not relevant to the STA or ETM context to generate a trimmed RTL representation.

The trimmed RTL representation may be output by the trimming engine 103 and stored in a memory or storage unit 104, and subsequently passed to a synthesis interface 105, which invokes downstream EDA tools for synthesis, place-and-route, or model extraction. One or more of these tools may execute on or be coordinated by a processor via instructions stored internally or externally on a memory. The processor may also handle timing analysis and model validation.

Collectively, 101-105 form a system for preprocessing RTL designs prior to block-level implementation. By removing logic that is not critical to interface timing or clock paths, system 100 reduces design complexity and accelerates turnaround time for STA and ETM activities across hierarchical chip designs.

According to an embodiment, to reduce the overall runtime associated with STA and ETM generation, the present disclosure targets the root cause of long runtimes: the size and complexity of the design. Conventional EDA tools often attempt to manage top-level STA complexity through hierarchical abstraction models generated at the block level, including ETMs, interface logic modules (ILMs), and other forms of block-level timing abstraction. While these models can simplify top-level analysis, they are typically generated after full place-and-route (after the design has gone through physical implementation) of each sub-block, and rely on the corresponding post-routed database derived from the original RTL description. As a result, abstraction model generation provides no reduction in runtime during block-level implementation, and may introduce additional processing time, further delaying top-level analysis.

In contrast, the methodology described herein addresses both the block-level and top-level runtime delays by eliminating unnecessary logic directly from the RTL representation. For many top-level STA activities, such as ETM generation and constraint debugging, a complete sub-block netlist is not required. These tasks primarily depend on interface-level timing and clock-related paths. By trimming RTL logic that is not relevant to these top-level concerns, the design becomes substantially smaller without affecting the accuracy of key timing analyses.

Because RTL-level trimming incurs minimal computational overhead, it enables rapid preprocessing of design blocks prior to synthesis and physical implementation. Following trimming, the runtime of downstream operations, including synthesis, automatic place-and-route, and STA, is significantly reduced. When these streamlined blocks are integrated into the top-level design, the reduced block sizes further accelerate top-level STA and ETM workflows, thereby enabling faster and more efficient verification of timing constraints.

According to various embodiments, the disclosed methodology reduces overall turnaround time in STA and ETM generation by removing logic that is not relevant to top-level timing concerns. In particular, the approach involves trimming portions of the RTL design that do not impact top-level interface timing or clock-related paths. This logic reduction significantly reduces the size and complexity of sub-blocks prior to synthesis and physical implementation, thereby accelerating downstream processing steps.

The trimming process may be selectively applied to one or more blocks within a hierarchical design. Users (or computer-implemented subroutines) may designate which blocks are to be trimmed and identify specific logic elements, such as RTL modules, instances, or cells, to be retained. Retention may be specified by marking the corresponding elements with a “dont_touch” label or equivalent directive, ensuring that they are preserved during the trimming process. The remaining logic, deemed irrelevant to the top-level STA context, may then be excluded from further processing.

The methodology may be particularly effective in abutted design flows, in which clock distribution is pushed down from the top level into sub-blocks. In such configurations, the timing paths of interest may be localized to well-defined interface and clock domains, making it feasible to eliminate substantial portions of unrelated internal logic without compromising STA coverage at the system level.

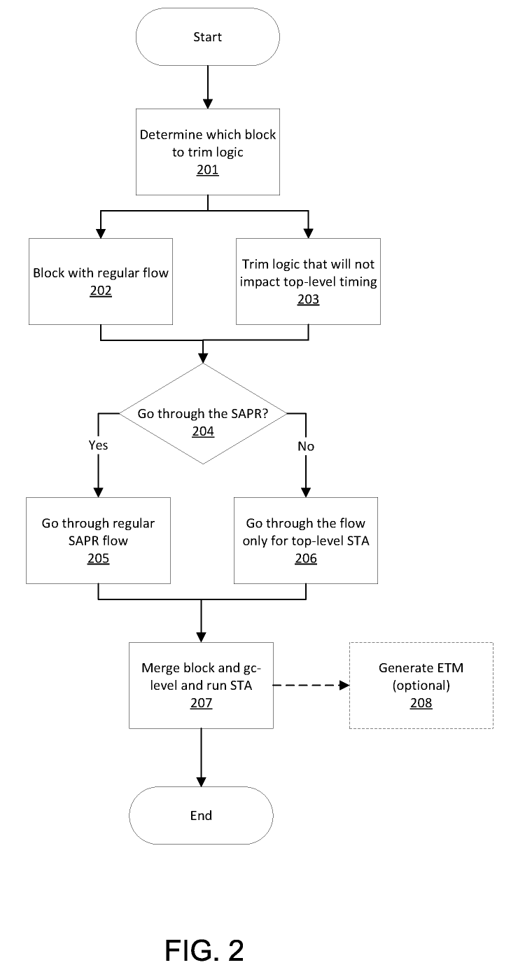

FIG. 2 is a flowchart illustrating a method for trimming design logic to accelerate STA and/or ETM generation in hierarchical designs, according to an embodiment.

The steps shown in FIG. 2 may be performed by one or more processors, tools, or logic modules, either on a single system or distributed across multiple devices. Execution order of the steps may vary; for instance, trimming and analysis steps may be performed iteratively or in parallel. Decisions such as block selection or implementation depth may be made manually, programmatically, or through a combination of both.

Referring to FIG. 2, at step 201, after the process begins, it is determined which block and what logic is not necessary for top-level timing closure. This determination may be based on design expertise, particularly with regard to verifying predetermined parameters, such as clock path combinational logic used for system-level clock control. For example, a user may select one or more blocks for logic reduction based on whether they contribute to the timing paths of interest. In alternative embodiments, machine learning models or other trainable networks may be used to determine which block to trim.

Blocks that do not require trimming are passed through step 202, where they continue through the standard flow without modification. At the same time, blocks identified for trimming follow the path to step 203, where irrelevant RTL logic is eliminated. Logic that contributes to top-level timing, such as block interface paths and clock-related structures, is retained. In abutted designs, where the clock tree is pushed down into sub-blocks, it may be sufficient to retain only the distributed clock logic, enabling the rest of the internal logic to be removed safely.

At step 204, the process determines whether the block should proceed through a full synthesis and automatic place-and-route (SAPR) flow. If SAPR selected, the block advances to step 205, where it undergoes the complete SAPR process. Depending on the required level of timing accuracy, a user may choose to save timing analysis results at various stages of implementation, such as after placement (post-place), after clock-tree synthesis (post-CTS), or after routing (post-route), to support subsequent STA or ETM generation.

Alternatively, if SAPR is not selected at step 204, a block that does not require full physical implementation follows the path to step 206, where a lightweight flow tailored for top-level STA is applied. This minimal flow skips unnecessary SAPR stages, reducing runtime while still producing the necessary interface-level timing views.

The block is then brought to step 207, where it is merged with the top-level design (global chip (GC) level), and full-chip STA is performed. Optionally, when the design includes an intellectual property (IP) block or other reusable module, step 208 allows for ETM generation to support top-level integration without requiring detailed block internals.

The process then ends, completing the STA and/or ETM generation process. By reducing unnecessary logic early in the RTL stage and selectively applying physical design effort, this methodology enables faster and more efficient design closure in large-scale hierarchical systems.

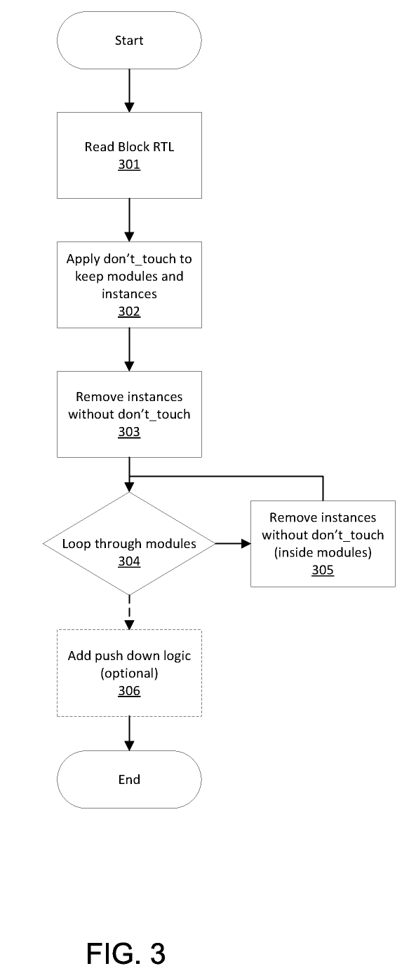

FIG. 3 is a flowchart illustrating a design trimming method for reducing unnecessary RTL logic within one or more blocks prior to synthesis and STA, according to an embodiment. This trimming process may be applied to multiple blocks in parallel, allowing efficient preprocessing across the full design hierarchy.

The steps shown in FIG. 3 may be executed by one or more processors, automation tools, or logic modules, and may be applied independently to each design block. These operations can be performed in parallel across multiple blocks or sequentially on a per-block basis, depending on system resources and workflow requirements. Decisions regarding which modules or instances to preserve using dont_touch attributes may be made manually by the user, through scripted automation, or by a combination of both approaches.

Referring to FIG. 3, the process begins with step 301, where the RTL for a selected block is read into the system. In step 302, a user identifies which RTL modules or instances are relevant to top-level STA and marks them with a dont_touch attribute to ensure they are preserved. All other logic is considered eligible for removal. Alternatively, this step may be automated using predefined parameters to identify the RTL modules or instances.

At step 303, the system eliminates top-level instances that are not marked with dont_touch. The process continues to step 304, where each remaining module (or self-contained unit of RTL) is examined individually. For each such module, at step 305, internal instances that lack the dont_touch designation are also removed.

In step 306, optional top-level pushdown logic may be inserted, particularly in abutted designs where clock distribution is handled within sub-blocks. This step ensures that any clock-related logic required for top-level STA is preserved even after internal trimming.

By executing this trimming process for each block independently, and in parallel for each block, the flow enables a significant reduction in design complexity ahead of STA or ETM generation, while preserving only the RTL components relevant to top-level timing integrity.

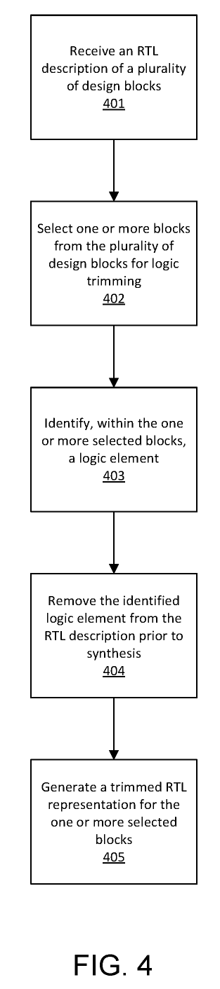

FIG. 4 is a flowchart illustrating a method for reducing STA runtime in a hierarchical circuit design, according to an embodiment.

The steps described in FIG. 4 may be performed in the order shown, in a different order, or in parallel, depending on implementation requirements. In some embodiments, certain steps may be omitted, combined, or substituted with alternative operations, and additional steps may be included. The method may be performed by one or more computing systems, including an EDA application operating on a general-purpose processor, a specialized RTL processing engine, or a dedicated hardware workstation configured to manage hierarchical circuit design.

Referring to FIG. 4, in step 401, an RTL description of a plurality of design blocks is received. The RTL may define multiple modules in a hierarchical SoC design and may be written in a hardware description language such as Verilog.

In step 402, one or more blocks are selected for logic trimming. Selection may be based on design knowledge, such as which blocks contribute minimally to top-level timing.

In step 403, a logic element is identified within the one or more selected block. These elements may include module instances, assignments, or paths that do not impact top-level timing analysis.

In step 404, the identified logic element is removed from the RTL prior to synthesis. Removal at this stage reduces the size and complexity of downstream netlists.

In step 405, a trimmed RTL representation is generated for the one or more selected blocks. This trimmed RTL representation preserves relevant timing behavior at the interface while omitting non-essential internal logic, enabling faster STA runs.

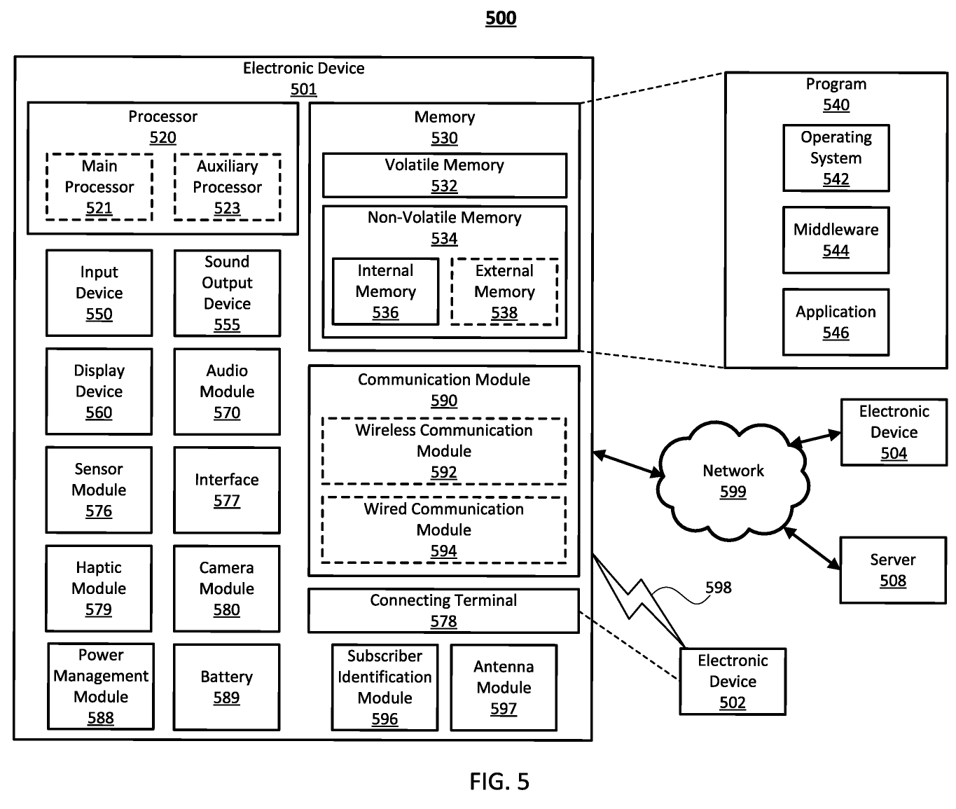

FIG. 5 is a block diagram of an electronic device in a network environment, according to an embodiment.

Referring to FIG. 5, an electronic device 501 in a network environment 500 may communicate with an electronic device 502 via a first network 598 (e.g., a short-range wireless communication network), or an electronic device 504 or a server 508 via a second network 599 (e.g., a long-range wireless communication network). The electronic device 501 may communicate with the electronic device 504 via the server 508. The electronic device 501 may include a processor 520, a memory 530, an input device 550, a sound output device 555, a display device 560, an audio module 570, a sensor module 576, an interface 577, a haptic module 579, a camera module 580, a power management module 588, a battery 589, a communication module 590, a subscriber identification module (SIM) card 596, or an antenna module 597. In one embodiment, at least one (e.g., the display device 560 or the camera module 580) of the components may be omitted from the electronic device 501, or one or more other components may be added to the electronic device 501. Some of the components may be implemented as a single IC. For example, the sensor module 576 (e.g., a fingerprint sensor, an iris sensor, or an illuminance sensor) may be embedded in the display device 560 (e.g., a display).

The processor 520 may execute software (e.g., a program 540) to control at least one other component (e.g., a hardware or a software component) of the electronic device 501 coupled with the processor 520 and may perform various data processing or computations.

In some embodiments, the processor 520 may be configured to execute one or more software modules stored in the memory 530 to perform RTL-level logic trimming operations as described with respect to FIGS. 2-4. For example, the processor may analyze RTL descriptions of sub-blocks received over the network 599, identify modules or instances marked with dont_touch directives, and remove unmarked logic to generate trimmed RTL representations suitable for top-level STA. These operations may be initiated manually through an input device 550 or automatically in response to configuration data received via the communication module 590.

The trimmed RTL data may then be stored temporarily in the memory 530 or transmitted via the communication module 590 to a server 508 for distributed processing. Alternatively, the processor 520 may itself invoke synthesis or abstraction tools to generate ETMs from the reduced logic representations, using local computing resources. Power management operations executed by the power management module 588 and battery 589 may dynamically adjust processing performance based on workload demands associated with the trimming and timing analysis workflows.

In cloud-connected implementations, the server 508 may coordinate trimming operations across multiple electronic devices 501, each of which handles a subset of design blocks in parallel. This distributed flow may leverage sensor module 576 data or system telemetry to optimize workload distribution and compute allocation. As such, the system architecture shown in FIG. 5 provides a practical execution environment for implementing the trimming-based STA acceleration techniques described throughout this disclosure.

As at least part of the data processing or computations, the processor 520 may load a command or data received from another component (e.g., the sensor module 576 or the communication module 590) in volatile memory 532, process the command or the data stored in the volatile memory 532, and store resulting data in non-volatile memory 534. The processor 520 may include a main processor 521 (e.g., a central processing unit (CPU) or an application processor (AP)), and an auxiliary processor 523 (e.g., a GPU, an image signal processor (ISP), a sensor hub processor, or a communication processor (CP)) that is operable independently from, or in conjunction with, the main processor 521. Additionally or alternatively, the auxiliary processor 523 may be adapted to consume less power than the main processor 521, or execute a particular function. The auxiliary processor 523 may be implemented as being separate from, or a part of, the main processor 521.

The auxiliary processor 523 may control at least some of the functions or states related to at least one component (e.g., the display device 560, the sensor module 576, or the communication module 590) among the components of the electronic device 501, instead of the main processor 521 while the main processor 521 is in an inactive (e.g., sleep) state, or together with the main processor 521 while the main processor 521 is in an active state (e.g., executing an application). The auxiliary processor 523 (e.g., an image signal processor or a communication processor) may be implemented as part of another component (e.g., the camera module 580 or the communication module 590) functionally related to the auxiliary processor 523.

The memory 530 may store various data used by at least one component (e.g., the processor 520 or the sensor module 576) of the electronic device 501. The various data may include, for example, software (e.g., the program 540) and input data or output data for a command related thereto. The memory 530 may include the volatile memory 532 or the non-volatile memory 534. Non-volatile memory 534 may include internal memory 536 and/or external memory 538.

The program 540 may be stored in the memory 530 as software, and may include, for example, an operating system (OS) 542, middleware 544, or an application 546.

The input device 550 may receive a command or data to be used by another component (e.g., the processor 520) of the electronic device 501, from the outside (e.g., a user) of the electronic device 501. The input device 550 may include, for example, a microphone, a mouse, or a keyboard.

The sound output device 555 may output sound signals to the outside of the electronic device 501. The sound output device 555 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 560 may visually provide information to the outside (e.g., a user) of the electronic device 501. The display device 560 may include, for example, a display, a hologram device, or a projector and control circuitry to control a corresponding one of the display, hologram device, and projector. The display device 560 may include touch circuitry adapted to detect a touch, or sensor circuitry (e.g., a pressure sensor) adapted to measure the intensity of force incurred by the touch.

The audio module 570 may convert a sound into an electrical signal and vice versa. The audio module 570 may obtain the sound via the input device 550 or output the sound via the sound output device 555 or a headphone of an external electronic device 502 directly (e.g., wired) or wirelessly coupled with the electronic device 501.

The sensor module 576 may detect an operational state (e.g., power or temperature) of the electronic device 501 or an environmental state (e.g., a state of a user) external to the electronic device 501, and then generate an electrical signal or data value corresponding to the detected state. The sensor module 576 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 577 may support one or more specified protocols to be used for the electronic device 501 to be coupled with the external electronic device 502 directly (e.g., wired) or wirelessly. The interface 577 may include, for example, a high- definition multimedia interface (HDMI), a universal serial bus (USB) interface, a secure digital (SD) card interface, or an audio interface.

A connecting terminal 578 may include a connector via which the electronic device 501 may be physically connected with the external electronic device 502. The connecting terminal 578 may include, for example, an HDMI connector, a USB connector, an SD card connector, or an audio connector (e.g., a headphone connector).

The haptic module 579 may convert an electrical signal into a mechanical stimulus (e.g., a vibration or a movement) or an electrical stimulus which may be recognized by a user via tactile sensation or kinesthetic sensation. The haptic module 579 may include, for example, a motor, a piezoelectric element, or an electrical stimulator.

The camera module 580 may capture a still image or moving images. The camera module 580 may include one or more lenses, image sensors, image signal processors, or flashes. The power management module 588 may manage power supplied to the electronic device 501. The power management module 588 may be implemented as at least part of, for example, a power management IC (PMIC).

The battery 589 may supply power to at least one component of the electronic device 501. The battery 589 may include, for example, a primary cell which is not rechargeable, a secondary cell which is rechargeable, or a fuel cell.

The communication module 590 may support establishing a direct (e.g., wired) communication channel or a wireless communication channel between the electronic device 501 and the external electronic device (e.g., the electronic device 502, the electronic device 504, or the server 508) and performing communication via the established communication channel. The communication module 590 may include one or more communication processors that are operable independently from the processor 520 (e.g., the AP) and supports a direct (e.g., wired) communication or a wireless communication. The communication module 590 may include a wireless communication module 592 (e.g., a cellular communication module, a short-range wireless communication module, or a global navigation satellite system (GNSS) communication module) or a wired communication module 594 (e.g., a local area network (LAN) communication module or a power line communication (PLC) module). A corresponding one of these communication modules may communicate with the external electronic device via the first network 598 (e.g., a short-range communication network, such as BLUETOOTH^{TM}, wireless-fidelity (Wi-Fi) direct, or a standard of the Infrared Data Association (IrDA)) or the second network 599 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 592 may identify and authenticate the electronic device 501 in a communication network, such as the first network 598 or the second network 599, using subscriber information (e.g., international mobile subscriber identity (IMSI)) stored in the subscriber identification module 596.

The antenna module 597 may transmit or receive a signal or power to or from the outside (e.g., the external electronic device) of the electronic device 501. The antenna module 597 may include one or more antennas, and, therefrom, at least one antenna appropriate for a communication scheme used in the communication network, such as the first network 598 or the second network 599, may be selected, for example, by the communication module 590 (e.g., the wireless communication module 592). The signal or the power may then be transmitted or received between the communication module 590 and the external electronic device via the selected at least one antenna.

Commands or data may be transmitted or received between the electronic device 501 and the external electronic device 504 via the server 508 coupled with the second network 599. Each of the electronic devices 502 and 504 may be a device of a same type as, or a different type, from the electronic device 501. All or some of operations to be executed at the electronic device 501 may be executed at one or more of the external electronic devices 502, 504, or 508. For example, if the electronic device 501 should perform a function or a service automatically, or in response to a request from a user or another device, the electronic device 501, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 501. The electronic device 501 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method for reducing static timing analysis (STA) runtime in a hierarchical circuit design, the method comprising:
receiving a register-transfer level (RTL) description of a plurality of design blocks;
selecting one or more blocks from the plurality of design blocks for logic trimming;
identifying, within the one or more selected blocks, a logic element;
removing the identified logic element from the RTL description prior to synthesis; and
generating a trimmed RTL representation for the one or more selected blocks.

2. The method of claim 1, wherein the selecting comprises receiving user input specifying the one or more blocks.

3. The method of claim 1, wherein identifying the logic element comprises analyzing the RTL description to determine whether the logic element contributes to an interface path or clock-related timing path.

4. The method of claim 1, further comprising preserving a logic element designated with a keep directive in the RTL description.

5. The method of claim 1, wherein the removing comprises deleting RTL modules or instances that are not designated as required for top-level timing.

6. The method of claim 1, wherein the trimming is applied independently to each selected block in parallel.

7. The method of claim 1, further comprising inserting clock-related logic into the trimmed RTL representation for each selected block in an abutted design configuration.

8. The method of claim 1, further comprising generating an extracted timing model (ETM) for each trimmed block based on the trimmed RTL representation.

9. The method of claim 1, further comprising integrating the trimmed blocks into a top-level design and performing STA on the integrated design.

10. The method of claim 1, wherein removing the identified logic element prior to synthesis reduces runtime of at least one of logic synthesis, place-and-route, or STA.

11. An apparatus comprising:
a processor; and
a non-transitory computer-readable storage medium storing instructions that, when executed by the processor, cause the apparatus to:
receive a register-transfer level (RTL) description of a plurality of design blocks,
select one or more blocks from the plurality of design blocks for logic trimming,
identify, within the one or more selected blocks, a logic element,
remove the identified logic element from the RTL description prior to synthesis, and
generate a trimmed RTL representation for the one or more selected blocks.

12. The apparatus of claim 11, wherein the instructions further cause the apparatus to receive user input specifying the one or more blocks.

13. The apparatus of claim 11, wherein the instructions further cause the apparatus to analyze the RTL description to determine whether the logic element contributes to an interface path or clock-related timing path.

14. The apparatus of claim 11, wherein the instructions further cause the apparatus to preserve a logic element designated with a keep directive in the RTL description.

15. The apparatus of claim 11, wherein the instructions further cause the apparatus to delete RTL modules or instances that are not designated as required for top-level timing.

16. The apparatus of claim 11, wherein the instructions further cause the apparatus to apply the logic trimming independently to each selected block in parallel.

17. The apparatus of claim 11, wherein the instructions further cause the apparatus to insert clock-related logic into the trimmed RTL representation for each selected block in an abutted design configuration.

18. The apparatus of claim 11, wherein the instructions further cause the apparatus to generate an extracted timing model (ETM) for each trimmed block based on the trimmed RTL representation.

19. The apparatus of claim 11, wherein the instructions further cause the apparatus to integrate the trimmed blocks into a top-level design and perform STA on the integrated design.

20. The apparatus of claim 11, wherein the instructions further cause the apparatus to reduce runtime of at least one of logic synthesis, place-and-route, or STA by removing the identified logic elements prior to synthesis.
